(19) United States
(12) Patent Application Publication
(10) Pub. No.: US 2026/0108827 A1
(43) Pub. Date: Apr. 23, 2026

(54) PITOT TUBE PUMP CAPABLE OF CONDUCTING CONTINUOUS OIL-WATER SEPARATION

(71) Applicant: NANTONG UNIVERSITY, Nantong, Jiangsu (CN)

(72) Inventors: Yongfei YANG, Nantong (CN); Weidong SHI, Nantong (CN); Rui WU, Nantong (CN); Linwei TAN, Nantong (CN); Yupeng CAO, Nantong (CN); Zhengang WANG, Nantong (CN); Gaowei WANG, Nantong (CN)

(21) Appl. No.: 18/574,731

(22) PCT Filed: Aug. 28, 2023
(86) PCT No.: PCT/CN2023/115166

§ 371 Date: Dec. 15, 2025

(30) Foreign Application Priority Data
Mar. 27, 2023 (CN) 202310305267.0

(51) Int. Cl. B01D 17/02; F04D 1/06; F04F 5/54

(52) U.S. Cl. CPC B01D 17/0217; F04D 1/06; F04F 5/54

(57) ABSTRACT

A pitot tube pump capable of conducting continuous oil-water separation is provided, including a rotating main shaft, a rotating portion, a fixed housing, and pitot tubes. Two pitot tubes, which are L-shaped, are provided. A vertical portion of each pitot tube is arranged in the rotating portion, a horizontal portion of each pitot tube extends in a direction away from the rotating main shaft. The vertical portions of the two pitot tubes are different in length, and a separated liquid inlet is arranged at an end portion of the vertical portion of each pitot tube. In an operating state, the separated liquid inlets of the two pitot tubes are located at both sides of an oil-water interface, in a direction opposite to a rotating direction of the rotating main shaft. The pitot tube pump provided in the present disclosure has a single-stage structure and few components, and thus the structure is simple and reliable, compact in size, parts can be easily replaced and the maintenance is relatively simple. Compared with other pumps, the later disassembling and maintenance are simpler and easier. Due to its simple structure, the input of manpower and material resources as well as production and maintenance costs are reduced, and the pitot tube pump is more economical and practical to use.

### TECHNICAL FIELD

The present disclosure belongs to the technical field of pitot tube pumps, and in particular relates to a pitot tube pump capable of conducting continuous oil-water separation.

### BACKGROUND

At present, mainstream physical methods for oil-water separation include: (1) Gravity separation method: due to the different relative densities of oil, gas and water, an oil-water mixture with certain components will form a certain proportion of oil, gas and water phase when the system is in equilibrium at a certain pressure and temperature. By increasing the density of water, expanding the density difference between oil and water, and reducing the viscosity of oil, the sedimentation separation velocity will be increased, thus increasing the separation efficiency. (2) Mechanical separation method: although a grease trap method therein is simple, the floor space is large. To overcome the shortage, mechanical separation equipment can be used to make oily wastewater form local vortexes or zigzag collisions in the separation equipment, or narrow channels can be used to capture and coalesce fine oil droplets to increase the particle size of oil droplets and reduce residence time, so as to achieve better separation effect. (3) Coarse graining method: in this method, by taking advantage of the significant difference in affinity between oil and water relative to coalescent materials, when oily wastewater passes through a lipophilic coalescent material, fine oil particles in the water are trapped and attached to the surface or pores of the material, and the trapped oil droplets are wetted and spread on the surface of the material, and further collide with the surrounding oil particles to coalesce, and the oil droplets are gradually coarse-grained. When the buoyancy of the oil droplets is greater than the adhesion energy between oil and solid, the oil particles peel off from the solid surface and float up for separation. (4) Centrifugal separation method: in this method, by taking advantage of the centrifugal force generated by rapid rotation, water with high density flows outward along an annular path, and oil with low density is thrown inward to coalesce into large oil droplets to float up for separation. The separation efficiency is increased with the increase of rotating speed, and the emulsified oil in water can be separated by an ultra-high-speed centrifuge.

Pitot tube pumps are widely used in electronics, papermaking, metallurgy, carbon black, chemical engineering, fertilizer and other industries due to the advantages of high efficiency and high stability, which are ideal substitutes for high-speed centrifugal pumps, high-pressure multistage centrifugal pumps, and partial positive displacement pumps. At present, pitot tube pumps have become the preferred equipment for infusion pumps of hole flushing system in the automobile manufacturing industry and feed pumps in the carbon black production line. However, there is no combination between pitot tube pumps and oil-water separation in the prior art.

### SUMMARY

An objective of the present disclosure is to provide a pitot tube pump capable of conducting continuous oil-water separation, so as to solve the defects and problems proposed in the background art.

To achieve the objective above, an embodiment of the present disclosure provides
a pitot tube pump capable of conducting continuous oil-water separation, including a rotating main shaft, a rotating portion, a fixed housing, and pitot tubes. The rotating main shaft and the rotating portion are arranged to rotate synchronously, and the fixed housing is covered on a periphery of the rotating portion. An end of each pitot tube of the pitot tubes is inserted into the rotating portion, and another end of each pitot tube extends away from the rotating main shaft.

Two pitot tubes are provided, and each pitot tube is arranged in an L shape. A vertical portion of each pitot tube is inserted into the rotating portion, and a horizontal portion of each pitot tube extends outward in a direction away from the rotating main shaft. The vertical portions of the two pitot tubes are different in length, and a separated liquid inlet is arranged at an end portion of the vertical portion of each pitot tube. In an operating state, the separated liquid inlets of the two pitot tubes are located at both sides of an oil-water interface, in a direction opposite to a rotating direction of the rotating main shaft.

Preferably, a flat elliptic flow channel with a gradually increasing cross-sectional area is provided inside each pitot tube.

Preferably, outlet ends of the two pitot tubes are connected with an oil outlet pipeline and a water outlet pipeline, respectively. The horizontal portions of the two pitot tubes are connected to the oil outlet pipeline and the water outlet pipeline, respectively. The outlet ends of the pitot tubes are connected to the oil outlet pipeline and the water outlet pipeline by splines.

Preferably, a water outlet ball valve and an oil outlet ball valve are installed on the water outlet pipeline and the oil outlet pipeline, respectively.

Preferably, the fixed housing is wrapped around the periphery of the rotating portion. A protective cover is arranged at a side, pointing to the rotating portion, of the fixed housing, a central base is arranged inside the protective cover in the same direction as an axis direction of the pitot tubes, and the horizontal portion of each pitot tube is arranged to penetrate through the central base.

Preferably, a mechanical seal is further arranged on an inner wall of the protective cover, the pitot tubes and the mechanical seal are connected by keys, thus positions of the pitot tubes can be controlled in a radial direction.

Preferably, an annular channel is provided inside the protective cover in a direction pointed by the rotating main shaft. A mixed liquid inlet is arranged on a side wall of a side, away from the fixed housing, of the protective cover. An impeller inlet is further arranged on the protective cover, and the impeller inlet is configured for communicating the mixed liquid inlet with the annular channel.

Preferably, the rotating portion includes a rotating housing and an end wall, an impeller is arranged between the rotating housing and the end wall, the pitot tubes are located at a side, pointing to the rotating housing, of the impeller, a side, pointing to the end wall, of the impeller forms a radial groove with an inner wall of the end wall, a side wall of a side, pointing to the rotating housing, of the impeller forms a rotating cavity with an inner wall of the rotating housing, and the radial groove communicates with the annular channel.

Preferably, annular bulges are arranged on both ends of the central base in a length direction. The impeller is located at a periphery of the annular bulge at an end of the central base, and a fixing bolt is arranged outside the annular bulge at another end of the central base. The fixing bolt penetrates through a side wall of the protective cover and abuts against the annular bulge at another end of the central base.

The technical solution of the present disclosure has the following beneficial effects:
1. Since the pitot tube pump provided in the present disclosure is of a single-stage structure, the components are few, the structure is simple and reliable and compact in size, parts can be easily replaced, and the maintenance is relatively simple. Compared with other multi-stage pumps and high-speed pumps, the later disassembling and maintenance are simpler and easier. For operation cost, due to its simple structure, the input in manpower and material resources, as well as production and maintenance costs are reduced, and the pitot tube pump is more economical and practical to use.
2. Compared with other centrifugal pumps, the basic operation components of the pitot tube pump provided in the present disclosure are a rotating housing and two fixed pitot tubes. As the impeller and a rotary drum are connected as a whole to rotate synchronously, there is no friction loss of the disc in the process of obtaining kinetic energy by liquid. One of the main reasons for the low efficiency of the centrifugal pump is the friction loss of the impeller disc, and thus the operation efficiency of the pitot tube pump is higher than other centrifugal pumps with the same specific speed. Secondly, the pitot tube is extremely high in operation stability, and can achieve continuous operation when applied to oil-water separation. Compared with a traditional oil-water separation process, on the basis of increasing the operation efficiency, the pitot tube pump can operate for a long time, and the input in manpower and material resources can also be reduced.
3. The pitot tube pump provided in the present disclosure includes two pitot tubes, the liquid after oil-water mixing enters a rotating cavity rotating inside the rotating housing via a through groove. Under the action of centrifugal force, water with high density flows outward along the annular path, and oil with low density is thrown inward. As the two pitot tubes are placed at different distances from the central base, the two pitot tubes can pick up two types of liquids located at different positions after centrifugal separation, and then discharge the liquids through two outlet pipelines connected therein.
4. The pitot tube pump provided in the present disclosure includes two outlet pipelines, which not only can be used to discharge oil and water centrifugally separated by the rotating housing, but also can be used to conduct continuous oil-water separation after oils with different densities are mixed with water. Specifically, after different oils are mixed with water, due to the different densities of the oils, a position of an oil-water boundary layer will change accordingly after centrifugal separation is conducted by the pitot tube pump. If the pitot tube is controllable in a radial direction, centrifugal separation can be conducted after different oils are mixed with water. Therefore, in the design of the pitot tube pump, an outlet of an inner end of the pitot tube is connected to an outlet pipeline by splines, which means that the control of the pitot tube in the radial direction can be achieved by changing a connection angle between an inner spline and an outer spline, thus continuous oil-water separation can be conducted after oils with different densities are mixed with water.
5. In the pitot tube pump provided in the present disclosure, two ball control valves are installed on the water outlet pipeline and the oil outlet pipeline, respectively, for regulating the flow of oil and water, so as to solve the separation problem under different oil-water proportions.

### BRIEF DESCRIPTION OF THE DRAWINGS

FIG. 1 is a structural schematic diagram of a pitot tube pump capable of conducting continuous oil-water separation according to the present disclosure;

FIG. 2 is a schematic diagram of an internal sectional structure of a pitot tube component of a pitot tube pump capable of conducting continuous oil-water separation according to the present disclosure;

FIG. 3 is a sectional view of connections between an outlet of an inner end of pitot tubes and outlet pipelines of a pitot tube pump capable of conducting continuous oil-water separation according to the present disclosure; and

FIG. 4 is a schematic diagram of a sectional structure of two pitot tube components of a pitot tube pump capable of conducting continuous oil-water separation according to the present disclosure.

In the drawings:

1-rotating main shaft; 11-bearing seat; 12-angular contact ball bearing; 13-fixing bolt; 2-rotating portion; 21-rotating housing; 212-limit hole; 2121-fixing groove; 22-end wall; 221-through bolt; 222-through groove; 3-fixed housing; 31-limit groove; 4-sealing portion; 41-protective cover; 411-limit bolt; 412-annular channel; 413-mixed liquid inlet; 414-impeller inlet; 415-mechanical seal; 42-central base; 421-annular bulge; 422-fixing bolt; 43-impeller; 431-radial groove; 432-rotating cavity; 44-sealing seat; 5-pitot tube; 51-separated liquid inlet; 52-oil outlet pipeline; 521-oil outlet ball valve; 53-water outlet pipeline; 531-water outlet ball valve.

### DETAILED DESCRIPTION OF THE EMBODIMENTS

To make the technical problems to be solved by the present disclosure, the technical solutions and advantages more clearly, the present disclosure is described in detail below with reference to the accompanying drawings and specific embodiments.

Please refer to FIG. 1, a pitot tube pump capable of conducting continuous oil-water separation includes a rotating main shaft 1, a rotating portion 2, a fixed housing 3, a sealing portion 4, and pitot tubes 5. The rotating main shaft 1 and the rotating portion 2 are arranged to rotate synchronously, the fixed housing 3 is covered on a periphery of the rotating portion 2, and the sealing portion 4 is configured for sealing the rotating portion 2. One end of each pitot tube 5 is inserted into the rotating portion 2, and another end of each pitot tube extends towards an end away from the rotating main shaft 1.

Please refer to FIG. 1, the rotating main shaft 1 is arranged to extend in a length direction. In an embodiment, an end of the rotating main shaft 1 is connected to a motor, and another end of the rotating main shaft 1 is connected to the rotating portion 2. Moreover, the rotating main shaft 1 and the rotating portion 2 are arranged to rotate synchronously, a bearing seat 11 is arranged on a periphery of the rotating main shaft 1, an angular contact ball bearing 12 is installed inside the bearing seat 11, and the bearing seat 11 is configured for being connected to the rotating portion 2. In one embodiment, the bearing seat 11 abuts against a side of the rotating portion 2. Multiple fixing bolts 13 are arranged on an end face, pointing to the rotating portion 2, of the rotating main shaft 1. At least two fixing bolts 13 are provided, and the fixing bolts are inserted into the rotating portion 2, thus ensuring the synchronous rotation of the rotating main shaft 1 and the rotating portion 2.

Please refer to FIG. 1, the rotating portion 2 includes a rotating housing 21 and an end wall 22. A limit hole 212 is formed at a side, pointing to the rotating main shaft 1, of the rotating housing 21, the limit hole 212 is in fit with the rotating main shaft 1, and a fixing groove 2121 in fit with the fixing bolt 13 is formed in the limit hole 212. The end wall 22 overlaps with a projection of the rotating housing 21 on a vertical plane, and a through bolt 221 is arranged on a periphery of the end wall 22, which penetrates through the end wall 22 and is inserted into an extension portion 2111. A through groove 222 is formed at the center of the end wall 22 for the penetration of the pitot tubes 5.

Please refer to FIG. 1, the fixed housing 3 is wrapped around the periphery of the rotating portion 2. The fixed housing 3 is generally a cylindrical housing with an end open. An opening of the fixed housing 3 points to an end, away from the rotating main shaft 1, of the fixed housing 3. A limit groove 31 is formed at an end, pointing to the rotating main shaft 1, of the fixed housing 3, and the rotating main shaft 1 penetrates through the limit groove 31.

Referring to FIG. 1, the sealing portion 4 includes a protective cover 41 arranged at the opening of the fixed housing 3, a central base 42, an impeller 43, and a sealing seat 44. An end, pointing to the fixed housing 3, of the protective cover 41 is fixed with the fixed housing 3. In an embodiment, multiple limit bolts 411 are arranged on the protective cover 41, and the protective cover 41 is fixed with the fixed housing 3 through the limit bolts 411. An annular channel 412 is provided inside the protective cover 41 in a direction pointed by the rotating main shaft 1. A mixed liquid inlet 413 is arranged on a side wall of a side, away from the fixed housing 3, of the protective cover 41. An impeller inlet 414 is further arranged on the protective cover 41, and the impeller inlet 414 is configured for communicating the mixed liquid inlet 413 with the annular channel 412. In an embodiment, a mechanical seal 415 is further arranged on an inner wall of the protective cover 41.

The central base 42 is located in the annular channel 412 and extends in an axis direction of the annular channel 412. An end, pointing to the fixed housing 3, of the central base 42 is located between the end wall 22 and the rotating housing 21. Annular bulges 421 are arranged on both ends of the central base 42 in a length direction. The annular bulge 421 at an end, away from the fixed housing 3, of the central base 42 abuts against an inner wall of the annular channel 412. In an embodiment, a fixing bolt 422 is arranged on the protective cover 41, and the fixing bolt 422 penetrates through a side wall of the protective cover 41 and is inserted into the annular bulge 421.

The impeller 43 is located between the rotating housing 21 and the end wall 22. In an embodiment, the impeller 43 is sleeved outside a periphery of the annular bulge 421 at an end, pointing to the fixed housing 3, of the central base 42. A side, pointing to the end wall 22, of the impeller 43 forms a radial groove 431 with an inner wall of the end wall 22, and a side wall of a side, pointing to the rotating housing 21, of the impeller 43 forms a rotating cavity 432 with an inner wall of the rotating housing 21. The radial groove 431 communicates with the annular channel 412, and the periphery size of the impeller 43 is less than the size of the end wall 22 and less than the size of the inner wall of the rotating housing 21.

The sealing seat 44 is located at an end portion of an end, away from the fixed housing 3, of the protective cover 41, and an inner wall of the sealing seat 44 abuts against an end surface of the central base 42. In an embodiment, the section of the sealing seat 44 in an axis direction is T-shaped, and a peripheral wall of the sealing seat 44 abuts against an end surface of the protective cover 41.

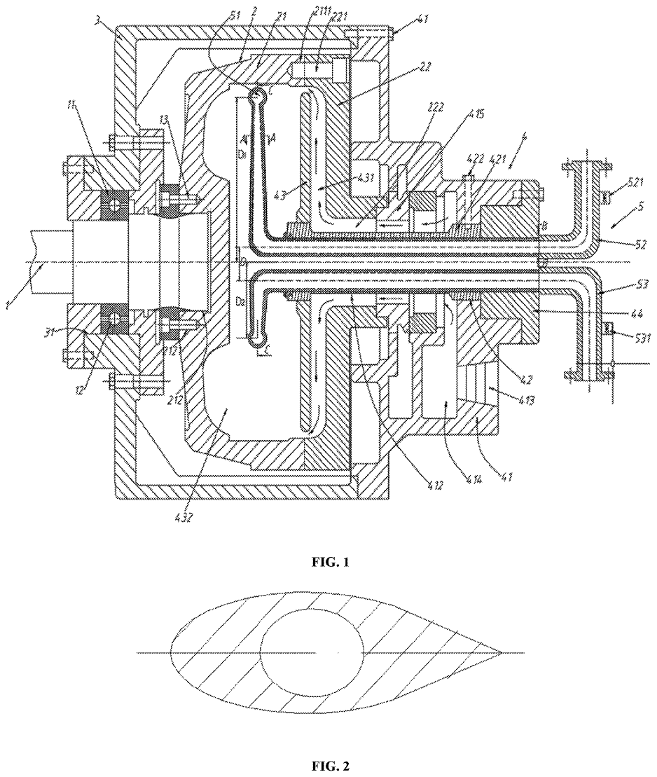

Please refer to FIG. 1, two pitot tubes 5 are provided, each pitot tube of the two pitot tubes 5 is arranged in an L shape. A horizontal portion of each pitot tube 5 extends along an axis direction of the central base 42. In an embodiment, the horizontal portion of each pitot tube 5 is rotatably arranged in the central base 42, one end of the horizontal portion is located between the impeller 43 and the rotating housing 21, and another end of the horizontal portion extends to an end away from the rotating housing 21 to penetrate through the central base 42 and the sealing seat 44, and an end surface of an end, away from the rotating housing 21, of the horizontal portion of the pitot tube 5 is coplanar with an end surface of the sealing seat 44. A vertical portion of each pitot tube 5 communicates with its horizontal portion. Moreover, the vertical portion of each pitot tube 5 is located between the impeller 43 and the rotating housing 21. In an embodiment, please refer to FIG. 2, a flat elliptic flow channel with a gradually increasing cross-sectional area is provided inside each pitot tube 5.

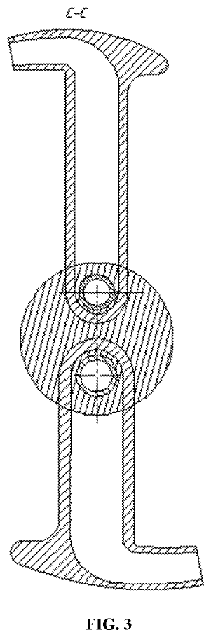

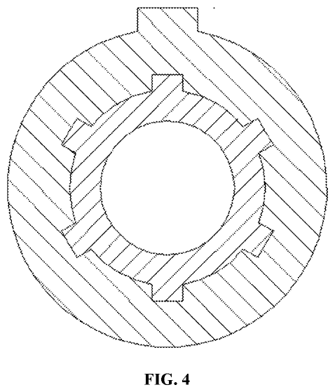

The two pitot tubes 5 are a water outlet pitot tube 5 and an oil outlet pitot tube 5. As shown in FIG. 3, the length of the vertical portion of the water outlet pitot tube 5 is greater than that of the vertical portion of the oil outlet pitot tube 5.

A separated liquid inlet 51 is arranged at an end portion of the vertical portion of each pitot tube 5. The separated liquid inlet 51 is configured for outputting oil or water after separation. In an embodiment, the separated liquid inlets 51 of the two pitot tubes 5 are located on both sides of an oil-water interface, in a direction opposite to a rotating direction of the rotating housing 21.

An oil outlet pipeline 52 and a water outlet pipeline 53 are arranged on outlet ends of the two pitot tubes 5, respectively. The horizontal portions of the two pitot tubes 5 are connected to the oil outlet pipeline 52 and the water outlet pipeline 53, respectively. In an embodiment, please refer to FIG. 4, the outlet ends of the pitot tubes 5 are connected to the oil outlet pipeline 52 and the water outlet pipeline 53 by splines, and the number of teeth of the spline is 6-10. In an embodiment, the pitot tubes 5 are connected to the mechanical seal 415 by keys. Therefore, position of the pitot tubes 5 is controllable in its radial direction.

In an embodiment, please refer to FIG. 1, an oil outlet ball valve 521 and a water outlet ball valve 531 are arranged on the oil outlet pipeline 52 and the water outlet pipeline 53, respectively. The oil outlet ball valve 521 and the water outlet ball valve 531 are configured for regulating the flow of oil and water, so as to solve the separation problem under different oil-water proportions.

The operating principle of the pitot tube pump provided in the present disclosure is as follows.

Oil-water mixed liquid enters the interior of the pitot tube pump through the mixed liquid inlet 413, flows into the annular channel 412 through the inlet 414 of the impeller 43, flows into the radial groove 431 through the annular channel 412, and then enters the rotating cavity 432.

An external motor is started to rotate the rotating main shaft 1, thus driving the rotating housing 21 to rotate together. After the oil-water mixed liquid is accelerated via the rotating housing 21, layered linearity may be generated in the rotating cavity 432 according to the principle of centrifugal separation. Because the end portions of the two pitot tubes 5 in the rotating cavity 432 are located at different distances from the central base 42, the separated liquid inlets 51 of the pitot tubes 5 face in an opposite direction to the rotating direction of the rotating housing 21, and thus two separated liquids can enter the pitot tubes 5 through the two separated liquid inlets 51. Finally, water entering the water outlet pitot tube 5 and oil entering the oil outlet pitot tube 5 flow out through the water outlet pipeline 53 and the oil outlet pipeline 52.

Pitot tube pump, also known as roto-jet pump, rotary jet pump, or rotary casing pump, is a novel high-pressure centrifugal pump with unique structure and operating principle, which is a centrifugal pump with small flow and high lift, and has incomparable advantages compared with common high-pressure pumps such as multistage pumps, high-speed pumps and piston pumps. Specifically, the pitot tube pump is of a single-stage structure (with only one impeller and one pitot tube), belongs to an extremely low specific speed pump, and thus a single-stage high-pressure pump with few components, simple and reliable structure, compact size and stable operation is realized. As only the mechanical seal is a quick-wear part, the replacement of the part is simpler, disassembling and maintenance are convenient, maintenance cost is reduced, and the pump is more economical to use. The pitot tube pump also has incomparable advantages in performance. Firstly, the efficiency is high, for the extremely low specific speed centrifugal pump, the reason for low efficiency is the friction loss of the impeller disc, which accounts for about 25% of the total loss, while the pitot tube pump has no friction loss of the disc and no volute hydraulic loss. Although there are hydraulic losses in a rotor cavity and a water collecting pipe, the efficiency is still higher than that of the centrifugal pump with the same specific speed. Secondly, the operation stability is high, as the liquid enters the rotor cavity after flowing out the impeller, there is a stable process in the rotor cavity, thus avoiding a hump phenomenon of Q-H curve of the low specific speed centrifugal pump. Meanwhile, the flow characteristic curve is smooth, and the liquid output has no pulsation, which is suitable for production posts requiring stable fluid transportation. In addition, it can be seen from the performance curve of the pitot tube pump that the pitot tube pump can operate stably at any flow rate point from zero flow rate to a design flow rate. However, the multi-stage pump and high-speed pump can only operate at working conditions around a design parameter point (that is, the multi-stage pump and high-speed pump cannot operate stably when the flow rate is much less than or greater than the design point), which determines the technological flexibility of the pitot tube pump.

As the housing of the pitot tube pump is rotatable, the liquid can be driven to rotate rapidly to generate a centrifugal force, such that water with a large density flows outward along an annular path, and oil with a small density is thrown inward. Afterwards, the pitot tubes are used to collect the separated liquids. After the high-speed liquids enter the pitot tubes, velocity energy of the liquids is converted into pressure energy as the cross-sectional area of the flat elliptic flow channels of the pitot tubes increases gradually, thus achieving continuous oil-water separation.

What is claimed is:

1. A pitot tube pump capable of conducting continuous oil-water separation, comprising a rotating main shaft, a rotating portion, a fixed housing, and pitot tubes, wherein the rotating main shaft and the rotating portion are arranged to rotate synchronously, and the fixed housing is covered on a periphery of the rotating portion, an end of each pitot tube of the pitot tubes is inserted into the rotating portion, and another end of each pitot tube extends towards an end away from the rotating main shaft, wherein
two pitot tubes are provided, each pitot tube of the two pitot tubes is arranged in an L shape, a vertical portion of each pitot tube is inserted into the rotating portion, a horizontal portion of each pitot tube extends outward in a direction away from the rotating main shaft; the vertical portions of the two pitot tubes are different in length, and a separated liquid inlet is arranged at an end portion of the vertical portion of each pitot tube; and in an operating state, the separated liquid inlets of the two pitot tubes are located at both sides of an oil-water interface, in a direction opposite to a rotating direction of the rotating main shaft.

2. The pitot tube pump capable of conducting continuous oil-water separation according to claim 1, wherein a flat elliptic flow channel with a gradually increasing cross-sectional area is provided inside each pitot tube.

3. The pitot tube pump capable of conducting continuous oil-water separation according to claim 1, wherein outlet ends of the two pitot tubes are connected with an oil outlet pipeline and a water outlet pipeline, respectively; the horizontal portions of the two pitot tubes are connected to the oil outlet pipeline and the water outlet pipeline, respectively; and the outlet ends of the pitot tubes are connected to the oil outlet pipeline and the water outlet pipeline by splines.

4. The pitot tube pump capable of conducting continuous oil-water separation according to claim 3, wherein a water outlet ball valve and an oil outlet ball valve are installed on the water outlet pipeline and the oil outlet pipeline, respectively.

5. The pitot tube pump capable of conducting continuous oil-water separation according to claim 1, wherein the fixed housing is wrapped around the periphery of the rotating portion, a protective cover is arranged at a side, pointing to the rotating portion, of the fixed housing, a central base is arranged inside the protective cover in a same direction as an axis direction of the pitot tubes, and the horizontal portion of each pitot tube is arranged to penetrate through the central base.

6. The pitot tube pump capable of conducting continuous oil-water separation according to claim 5, wherein a mechanical seal is further arranged on an inner wall of the protective cover, the pitot tubes and the mechanical seal are connected by keys, and thus positions of the pitot tubes are controlled in a radial direction.

7. The pitot tube pump capable of conducting continuous oil-water separation according to claim 5, wherein an annular channel is provided inside the protective cover in a direction pointed by the rotating main shaft, a mixed liquid inlet is arranged on a side wall of a side, away from the fixed housing, of the protective cover, an impeller inlet is further arranged on the protective cover, and the impeller inlet is configured for communicating the mixed liquid inlet with the annular channel.

8. The pitot tube pump capable of conducting continuous oil-water separation according to claim 7, wherein the rotating portion comprises a rotating housing and an end wall, an impeller is arranged between the rotating housing and the end wall, the pitot tubes are located at a side, pointing to the rotating housing, of the impeller, a side, pointing to the end wall, of the impeller forms a radial groove with an inner wall of the end wall, a side wall of a side, pointing to the rotating housing, of the impeller forms a rotating cavity with an inner wall of the rotating housing, and the radial groove communicates with the annular channel.

9. The pitot tube pump capable of conducting continuous oil-water separation according to claim 8, wherein annular bulges are arranged on both ends of the central base in a length direction, the impeller is located at a periphery of an annular bulge at an end of the central base, and a fixing bolt is arranged outside an annular bulge at another end of the central base, and the fixing bolt penetrates through a side wall of the protective cover and abuts against the annular bulge at another end of the central base.
